(19) United States
(12) Patent Application Publication
(10) Pub. No.: US 2013/0120467 A1
(43) Pub. Date: May 16, 2013

(54) COLOR SEQUENTIAL LIQUID CRYSTAL DISPLAY DEVICE

(71) Applicants: Hung-lung Hou, Shenzhen (CN); Chengming He, Shenzhen (CN)

(72) Inventors: Hung-lung Hou, Shenzhen (CN); Chengming He, Shenzhen (CN)

(73) Assignee: Shenzhen China Star Optoelectronics Technology Co., Ltd., Shenzhen (CN)

(21) Appl. No.: 13/379,661

(22) PCT Filed: Nov. 18, 2011
(86) PCT No.: PCT/CN11/82437

§ 371 Date: Dec. 21, 2011

(30) Foreign Application Priority Data
Nov. 15, 2011 (CN) 201120451146.X
Nov. 18, 2011 (CN) PCT/CN2011/082437

(51) Int. Cl. G09G 5/10; G09G 3/36

(52) U.S. Cl. 345/690; 345/88

(57) ABSTRACT

The color sequential LCD device comprises an LCD panel, a data drive circuit, a gate drive circuit and backlight units. The LCD panel comprises data lines disposed along a major-axis direction of a substrate of the LCD panel, gate lines orthogonally intersecting the data lines, and a plurality of color sequential displaying areas defined along the major-axis direction of the substrate. The data drive circuit disposed at one side of the substrate in the minor-axis direction applies image signals to the data lines. The gate drive circuit disposed at one side of the substrate in the major-axis direction applies strobe pulse to the gate lines. The backlight units disposed at one side of the substrate in the major-axis direction at least comprises red LEDs, green LEDs and blue LEDs. The invention improves the displaying effect due to increase the number of the color sequential displaying areas.

### BACKGROUND

1. Technical Field

The present disclosure relates to the technical field of liquid crystal displaying, and more particularly, to a color sequential liquid crystal display (LCD) device.

2. Description of Related Art

Referring to FIG. 1, there is shown a schematic cross-sectional view of color sequential LCD device in the prior art. In the prior art, color sequential LCD device comprises: an upper substrate 30; a lower substrate 35 used for an array substrate; a liquid crystal layer 38 sandwiched between the upper substrate 30 and the lower substrate 35; and RGB backlight lamps 39 for illuminating the LCD panel. The LCD panel comprises the upper substrate 30, the lower substrate 35 and the liquid crystal layer 38.

The upper substrate 30 and the lower substrate 35 are provided with a common electrode 32 and a pixel electrode 36 respectively. A voltage can be applied between the common electrode 32 and the pixel electrode 36 to drive the liquid crystal molecules in the liquid crystal layer 38 to rotate. A black matrix 31 is disposed between the upper substrate 30 and the common electrode 32 to block light from illuminating areas outside the pixel electrode 36 of the lower substrate 35. At positions of the lower substrate 35 that correspond to the black matrix 31 of the upper substrate 30 are formed with thin film transistors (TFTs) 37. The TFTs 37 are electrically connected to the pixel electrode 36 and used as switch elements.

Because the RGB backlight lamps 39 acting as a backlight unit emit light respectively in the said color sequential LCD device, no color filter (CF) layer is required. If each of the RGB backlight lamps 39 is lit up 60 times per second, then the RGB backlight lamps 39 are lit up 180 times per second in total and the three colors are mixed by virtue of the residual image effect in the user's eyes. For example, if the R backlight lamp is lit up and then the B backlight lamp is lit up, a purple color will be perceived by the user's naked eyes owing to the residual image effect. By use of this phenomenon, the RGB backlight lamps 39 overcome the problem that LCD devices using color filters have a low transmissivity and consequently a low overall luminance. Furthermore, because use of the three-color backlight lamps can provide a full color image, high luminance and high definition can be obtained; and because use of the expensive color filter is eliminated, the manufacturing cost is reduced. Therefore, the color sequential LCD device is suitable for use in large-size LCD apparatuses.

In order to describe a driving method of the color sequential LCD device, a portion of the array substrate of the LCD device is shown in FIG. 2. The lower substrate acting as the array substrate in the LCD device generally comprises: a plurality of gate lines 50 are disposed in a horizontal direction; a plurality of data lines 51 orthogonally intersect the gate lines 50; a plurality of pixel units are defined by the gate lines 50 and the data lines 51; a plurality of TFTs 37 are disposed into the pixel units; and a plurality of pixel electrodes 52 are electrically connected to the TFTs 37 respectively. Image signals are applied to the data lines 51, and strobe pulses are applied to the gate lines 50. The LCD device is driven by applying the strobe pulses to the gate lines 50. In order to improve the displaying quality, the strobe pulses are applied to the gate lines 50 through a linear sequence driving method. In this method, a gate drive circuit applies a voltage to the gate lines 50 one by one sequentially, and a strobe pulse voltage is applied to all the gate lines 50 to accomplish a frame. In other words, if the strobe pulse voltage is applied to an n^{th} gate line, then all the TFTs 37 connected with the gate line are applied the strobe pulse voltage to and then are turned on simultaneously. When the TFTs 37 are turned on, the image data signal will be stored in corresponding liquid crystal units and storage capacitors.

Then, the arraying directions of liquid crystal molecules in the liquid crystal units are changed according to the image data signal stored in the liquid crystal units and the voltage of the image data signal so that backlight can transmit through the liquid crystal units to display a desired image.

FIG. 3 is a timing diagram of the driving method of the color sequential LCD device. As shown in FIG. 3, firstly, all the TFTs 37 are turned on, liquid crystal molecules rotate to corresponding positions, and then the red backlight lamps R are turned on. Then in the same way, after the TFTs 37 are turned on again and the liquid crystal molecules rotate to corresponding positions, the green backlight lamps G are turned on. the blue backlight lamps B are turned on after the TFTs 37 are turned on in third time and the liquid crystal molecules rotate to corresponding positions. That is, each of the R, G and B backlight lamps 39 is arranged to be lit up once per frame respectively for the whole driving region. The driving within one period (one frame) of each of the backlight lamps shall be as follows: f=t_{TFT}+t_{LC}+T_{BL}, where f represents a duration of one frame, t_{TFT} represents a turn-on time of all the TFTs, t_{LC} represents a response time of the liquid crystal molecules, and T_{BL} represents a light-up time of the backlight lamp.

However, it is difficult for the aforesaid color sequential driving method to drive one frame because of the low response speed of the liquid crystal molecules. In order to solve this problem, a divided display area method (DDAM) is adopted to divide the displaying area into several sub-areas when the LCD device is driven.

As shown in FIG. 4 and FIG. 5, in an LCD device driven by the DDAM method, a gate driver 230 is disposed at one side in a major-axis direction of the substrate of an LCD panel and a data driver 240 is disposed at one side in a minor-axis direction of the substrate. Correspondingly, LED light sources 72 are disposed at two opposite sides of a light guide plate 90 in a major-axis direction of a light guide plate 90. The light guide plate 90 is disposed at the back side of the LCD panel (not shown), and each of the LED light sources 72 comprises LED lamps 73 arranged in one direction. The LED lamps 73 include red LEDs, green LEDs and blue LEDs arranged alternatively on a printed circuit board (PCB). The light guide plate 90 is divided into four areas so as to divide the LCD screen into four areas 90a, 90b, 90c and 90d. The gate driver 230 scans the four areas 90a, 90b, 90c and 90d of the LCD screen sequentially from top to bottom, correspondingly, the LED lamps 73 for the four areas 90a, 90b, 90c and 90d are turned on sequentially. The red light, the green light and the blue light from the LED lamps 73 turned on are scattered to sequentially illuminate the back side of the LCD panel.

As described above, the LED lamps 73 of the LED light sources 72 are sequentially turned on so that only LED lamps 73 corresponding to a specific division area of the light guide plate 90 are driven at a given time, thus displaying an image on the LCD panel in a color sequential manner. The backlight turn-on time of the color sequential LCD device is t_{BL}=f−t_{TFT}−t_{LC}.

However, the color sequential LCD device has the following drawback: the gate drive circuit is disposed at one side of the major axis of the substrate and the driving strobe pulse scans from top to bottom, so the light guide plate must be divided into a plurality of areas (four in this figure) from top to bottom correspondingly, which makes the number of the areas limited. Moreover, the backlight turn-on time is 5.5-5.5/4-4 (the twisting time of the liquid crystal molecules)=0.125 ms, which accounts for 2.27% of the duration of one frame and is very short. Furthermore, as the edge-lit backlight is used, it is impossible to dispose a large number of LED light sources at two opposite sides of the minor axis of the substrate due to the length restriction; and the long distance between the left side and the right side tends to cause non-uniformity of the luminance.

### BRIEF SUMMARY

The primary objective of the present disclosure is to provide a color sequential LCD device, which can prolong the backlight turn-on time and improve the displaying effect of the LCD device.

To achieve the aforesaid objective, the present disclosure provides a color sequential LCD device. The color sequential LCD device comprises an LCD panel, data drive circuits, a gate drive circuit, backlight units. The LCD panel comprises a plurality of data lines disposed in a substrate of the LCD panel along a major-axis direction of the substrate and a plurality of gate lines disposed in the substrate along a minor-axis direction of the substrate. The gate lines orthogonally intersect with the data lines, and a plurality of color sequential displaying areas are defined along the major-axis direction of the substrate. Data drive circuits are disposed at two opposite sides of the substrate in the minor-axis direction to provide image data to the data lines. A gate drive circuit is disposed at one side of the substrate in the major-axis direction to provide a strobe pulse to the gate lines. Backlight units at least comprise red LEDs, green LEDs and blue LEDs are disposed at two opposite sides of the substrate in the major-axis direction. The substrate is divided into a first driving section and a second driving section along the major-axis direction of the substrate. The data lines in the first driving section are disconnected with the data lines in the second driving section, and the data lines in the first driving section and the data lines in the second driving section are connected to corresponding data drive circuits respectively.

Preferably, the color sequential LCD device further comprises a light guide plate adjacent to the LCD panel.

Preferably, the number of scan lines in the first driving section is equal to the number of scan lines in the second driving section.

Preferably, the number of the scan lines is the same for each of the color sequential displaying areas.

Preferably, the red LEDs, the green LEDs and the blue LEDs are arranged alternately one by one.

The present disclosure further provides a color sequential LCD device. The color sequential LCD device comprises an LCD panel, a data drive circuit, a gate drive circuit, a backlight unit. The LCD panel comprises a plurality of data lines disposed in a substrate of the LCD panel along a major-axis direction of the substrate and a plurality of gate lines disposed in the substrate along a minor-axis direction of the substrate. The gate lines orthogonally intersect the data lines, and a plurality of color sequential displaying areas are defined along the major-axis direction of the substrate. A data drive circuit is disposed at one side of the substrate in the minor-axis direction to provide image data to the data lines. A gate drive circuit, being disposed at one side of the substrate in the major-axis direction to provide a strobe pulse to the gate lines. A backlight unit at least comprising red LEDs, green LEDs and blue LEDs, being disposed at one side in the major-axis direction of the substrate.

Preferably, the color sequential LCD device further comprises a light guide plate adjacent to the LCD panel.

Preferably, the LCD device further comprises another data drive circuit disposed at the other side of the substrate in the minor-axis direction.

Preferably, the substrate is divided into a first driving section and a second driving section along the major-axis direction of the substrate, the data lines in the first driving section are disconnected with the data lines in the second driving section, and the data lines in the first driving section and the data lines in the second driving section are connected to corresponding data drive circuits respectively.

Preferably, the number of scan lines in the first driving section is equal to the number of scan lines in the second driving section.

Preferably, the LCD device further comprises another backlight unit disposed at the other side of the substrate in the major-axis direction.

Preferably, the red LEDs, the green LEDs and the blue LEDs are arranged alternately one by one.

Preferably, the number of the scan lines is the same for each of the color sequential displaying areas.

According to the color sequential LCD device of the present disclosure, the data drive circuit is disposed at two sides in the minor-axis direction of the substrate and the gate drive circuit is disposed at one side in the major-axis direction of the substrate. As a result, the number of backlight division areas can be increased to prolong the backlight turn-on time, thus improving the displaying effect of the LCD device.

### BRIEF DESCRIPTION OF THE DRAWINGS

FIG. 1 is a schematic cross-sectional view of color sequential LCD device in a prior art;

FIG. 2 is a schematic partial view of a substrate of LCD device in the prior art;

FIG. 3 is a timing diagram of a driving method of color sequential LCD device in the prior art;

FIG. 4 is a schematic view of a backlight module of color sequential LCD device in the prior art;

FIG. 5 is a schematic view illustrating gate scanning in the prior art color sequential LCD device;

FIG. 6 is a schematic view of a substrate of a color sequential LCD device according to a first embodiment of the present disclosure;

FIG. 7 is a schematic view illustrating a scanning direction in the color sequential LCD device according to the first embodiment of the present disclosure;

FIG. 8 is a schematic view of a substrate of the color sequential LCD device according to a second embodiment of the present disclosure; and

FIG. 9 is a schematic view illustrating a scanning direction in the color sequential LCD device according to the second embodiment of the present disclosure.

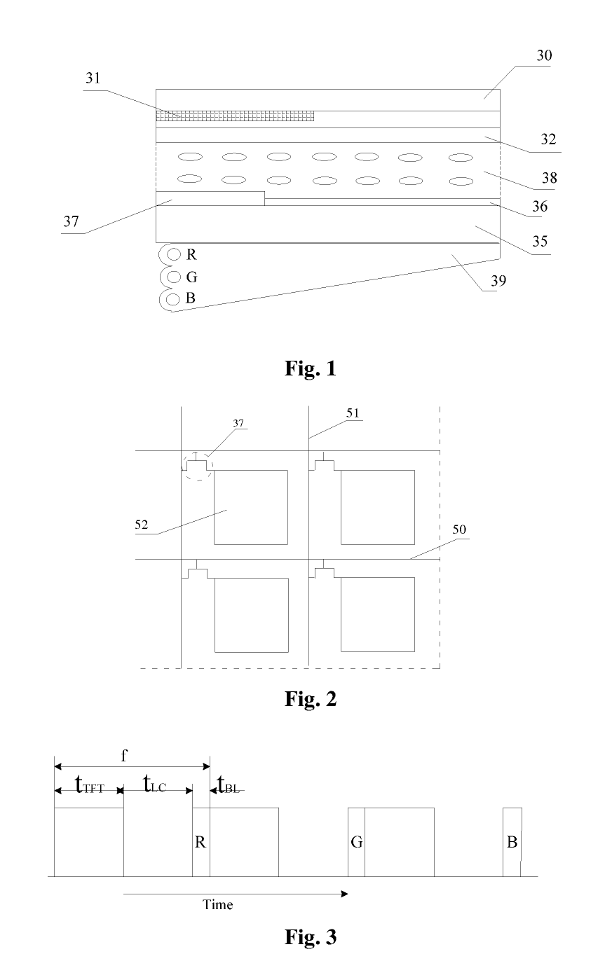

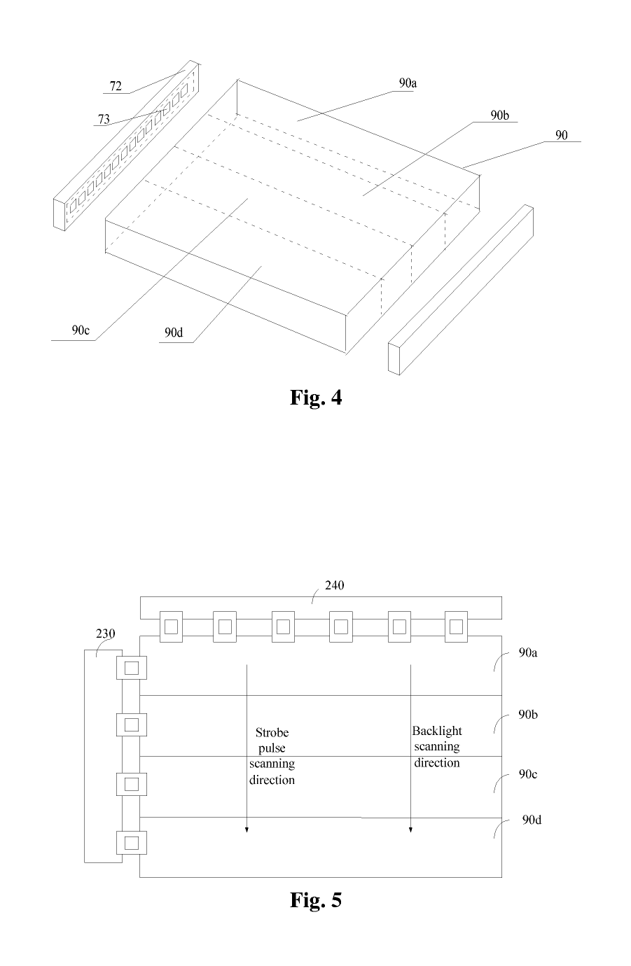

Hereinafter, implementations, functional features and advantages of the present disclosure will be further described with reference to embodiments thereof and the attached drawings.

### DETAILED DESCRIPTION

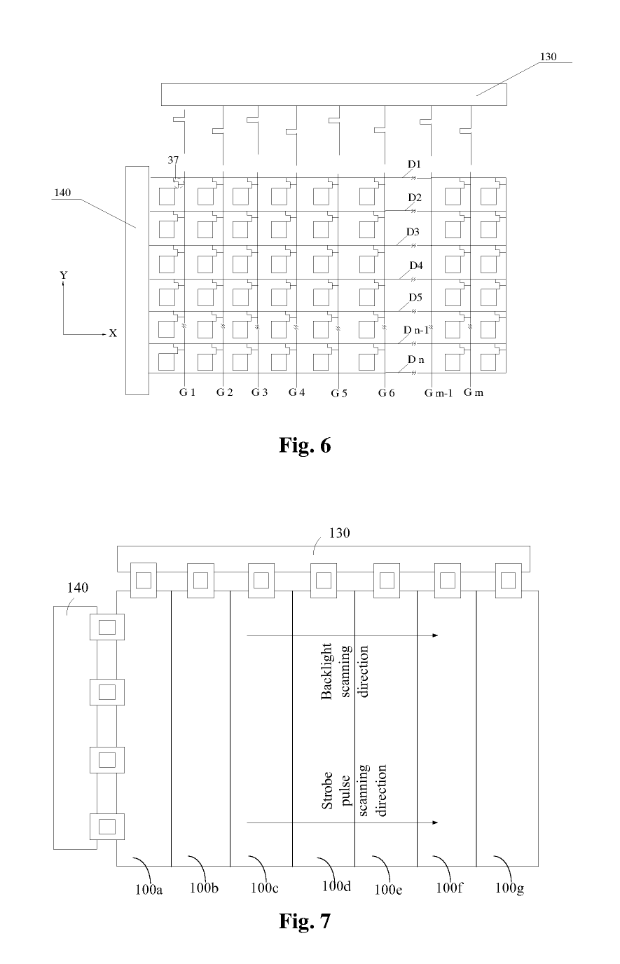

Referring to FIG. 6 and FIG. 7 together, FIG. 6 is a schematic view of a substrate of a color sequential LCD device according to a first embodiment of the present disclosure, and FIG. 7 is a schematic view illustrating a scanning direction in the color sequential LCD device according to the first embodiment of the present disclosure. The color sequential LCD device of the present disclosure comprises an LCD panel, a gate driver 130, a data driver 140 and a backlight module (not shown). As shown in FIG. 6, the LCD panel comprises a plurality of data lines D1, D2, D3, D4, D5 . . . Dn−1, and Dn disposed in a substrate of the LCD panel along a major-axis direction (an X-axis direction) of the substrate and a plurality of gate lines G1, G2, G3, G4, G5, G6 . . . Gm−1, and Gm disposed in the substrate along a minor-axis direction (a Y-axis direction) of the substrate. The gate lines orthogonally intersect the data lines to define a plurality of pixel units. The LCD panel is divided into a plurality of color sequential displaying areas along the major-axis direction of the substrate. The gate driver 130 is disposed at one side of the substrate in the major-axis direction of the substrate and is connected with a plurality of scan lines to provide strobe pulse signals to the plurality of scan lines. The data driver 140 is disposed at one side of the substrate in the minor-axis direction of the substrate and is connected with the plurality of data lines to provide image data to the data lines. The backlight module is disposed adjacent to the LCD panel and comprises backlight units and a light guide plate (LPG). The backlight units at least include red LEDs, green LEDs and blue LEDs, and are disposed at one side of the substrate in the major-axis direction. Preferably, the red LEDs, the green LEDs and the blue LEDs are arranged alternately one by one. Furthermore, the other side in the major-axis direction of the substrate may also be provided with backlight units; that is, two sides in the major-axis direction of the substrate are both provided with backlight units. The light guide plate is located beneath the LCD panel to transform a point light source emitted from the LED light sources into a uniform area light source for projecting to the LCD panel.

It is assumed that the gate driver 130 in conventional LCD panel were disposed at one side of the substrate in the minor-axis direction, the displaying area of the conventional LCD panel would be divided into four color sequential displaying areas from top to bottom; however, the gate driver 130 in the LCD panel of this embodiment is disposed at one side of the substrate in the major-axis direction, the LCD panel is divided into seven color sequential displaying areas 100a, 100b, 100c, 100d, 100e, 100f, and 100g from left to right. Each of the color sequential displaying areas comprises a plurality of gate lines. When one displaying area is scanned, the data driver 140 transmits the corresponding image data to the corresponding pixel units via the data lines, and the backlight units provide image colors corresponding to the displaying area.

In addition, among the plurality of color sequential displaying areas, the number of the scan lines is the same in each of the color sequential displaying areas.

As compared with the conventional color sequential LCD device in which four displaying areas are scanned sequentially from top to bottom, the LCD device in this embodiment is divided into seven displaying areas from left to right. As the backlight turn-on time t_{BL}=f−t_{TFT}−t_{LC} (f represents a duration of one frame, t_{TFT} represents a turn-on time of all TFTs, t_{LC} represents a response time of the liquid crystal molecules, and T_{BL} represents a light-up time of the backlight lamp) of the color sequential LCD device indicates, the response time of the TFTs of each of the displaying areas is decreased because of the increase of the number of the displaying areas, which prolongs the backlight turn-on time. Furthermore, as the backlight units are disposed at one side in the major-axis direction of the substrate, the number of the light sources is increased, which ensures the luminance and improves the displaying effect of the LCD panel.

Assuming that the color sequential LCD device comprises 320×240 pixels (arranged in 320 columns and 240 rows) and the scan frequency thereof is 180 Hz, then a displaying duration of one frame is 5.5 ms, and in contrast, the response time of the liquid crystal molecules in the prior art is about 4 ms. As the backlight turn-on time t_{BL}=f−t_{TFT}−t_{LC} (f represents a duration of one frame, t_{TFT} represents a turn-on time of all the TFTs, t_{LC} represents a response time of the liquid crystal molecules, and T_{BL} represents a light-up time of the backlight lamp) of the color sequential LCD device indicates, the backlight turn-on time of each of the displaying areas is 5.5−5.5/7−4 (the twisting time of the liquid crystal molecules)=0.714 ms. The backlight turn-on time accounts for a duty of 12.9% of the duration of one frame, and the duty is increased by about 10% as compared with the duty of 2.27% of the prior art. At the same time, the LCD device may further be provided with more LED light sources to improve the overall luminance of the LCD panel and the displaying effect of the LCD device.

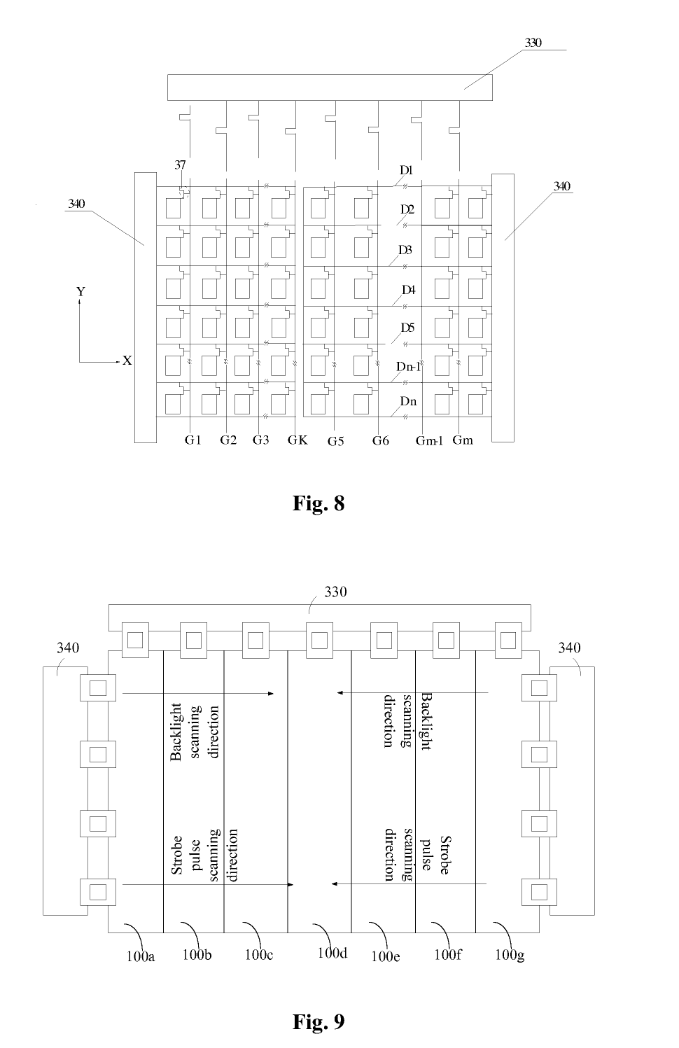

Referring further to FIG. 8 and FIG. 9, FIG. 8 is a schematic view of a substrate of the color sequential LCD device according to a second embodiment of the present disclosure, and FIG. 9 is a schematic view illustrating a scanning direction in the color sequential LCD device according to the second embodiment of the present disclosure. The color sequential LCD device in the second embodiment of the present disclosure differs from the aforesaid color sequential LCD device in the first embodiment in that, another data drive circuit 340 is further disposed at the other side of the substrate in the minor-axis direction of the substrate; that is, a data drive circuit 340 is disposed at each of the two opposite sides of the substrate in the minor-axis direction (the Y-axis direction) of the substrate respectively. The substrate is divided into a first driving section and a second driving section along the major-axis direction (the X-axis direction) of the substrate. Data lines in the first driving section are disconnected from data lines in the second driving section, and the data lines in the first driving section and the data lines in the second driving section are connected to the respective data drive circuits 340 as shown in FIG. 8. Thus, the gate drive circuit 330 can output scanning signals from two sides to a middle portion simultaneously, and image data voltage signals can be charged into the first group of the data lines and the second group of the data lines simultaneously, which shortens the charging time of the LCD panel. Preferably, the number of scan lines in the first driving section is equal to the number of scan lines in the second driving section, which ensures that the charging times of the data lines are the same for both the two driving sections.

Taking the aforesaid color sequential LCD device in the first embodiment as an example still, the color sequential LCD device comprises 320×240 pixels (arranged in 320 columns and 240 rows) and the scan frequency thereof is 180 Hz, and the duration of one frame is still 5.5 ms. Then, the backlight turn-on time of each of the displaying areas is 5.5−(5.5/7)×2−4 (the twisting time of the liquid crystal molecules)=1.1 ms. The backlight turn-on time accounts for a duty of 20% of the duration of one frame, and the duty is increased by about 18% as compared with the duty of 2.27% of the prior art.

According to the present disclosure, the gate drive circuit 330 is disposed at one side of the substrate in the major-axis direction of the substrate and the data drive circuits 340 are disposed at two opposite sides of the substrate in the minor-axis direction of the substrate. As a result, the number of backlight division areas is increased to prolong the backlight turn-on time, and the backlight units can be provided with more LED light sources, which further improves the overall luminance of the LCD panel and the displaying effect of the LCD device.

What described above are only preferred embodiments of the present disclosure but are not intended to limit the scope of the present disclosure. Accordingly, any equivalent structural or process flow modifications that are made on basis of the specification and the attached drawings or any direct or indirect applications in other technical fields shall also fall within the scope of the present disclosure.

What is claimed is:

1. A color sequential liquid crystal display (LCD) device, comprising:
an LCD panel, comprising a plurality of data lines disposed in a substrate of the LCD panel along a major-axis direction of the substrate and a plurality of gate lines disposed in the substrate along a minor-axis direction of the substrate, wherein the gate lines orthogonally intersect the data lines, and a plurality of color sequential displaying areas are defined along the major-axis direction of the substrate;
data drive circuits, being disposed at two opposite sides of the substrate in the minor-axis direction to provide image data to the data lines;
a gate drive circuit, being disposed at one side of the substrate in the major-axis direction to provide a strobe pulse to the gate lines; and
backlight units at least comprising red LEDs, green LEDs and blue LEDs, being disposed at two opposite sides of the substrate in the major-axis direction,
wherein the substrate is divided into a first driving section and a second driving section along the major-axis direction of the substrate, the data lines in the first driving section are disconnected with the data lines in the second driving section, and the data lines in the first driving section and the data lines in the second driving section are connected to corresponding data drive circuits respectively.

2. The color sequential LCD device of claim 1, further comprising a light guide plate adjacent to the LCD panel.

3. The color sequential LCD device of claim 2, wherein the number of scan lines in the first driving section is equal to the number of scan lines in the second driving section.

4. The color sequential LCD device of claim 3, wherein the number of the scan lines is the same for each of the color sequential displaying areas.

5. The color sequential LCD device of claim 1, wherein the number of the scan lines is the same for each of the color sequential displaying areas.

6. The color sequential LCD device of claim 4, wherein the red LEDs, the green LEDs and the blue LEDs are arranged alternately one by one.

7. The color sequential LCD device of claim 1, wherein the red LEDs, the green LEDs and the blue LEDs are arranged alternately one by one.

8. A color sequential LCD device, comprising:
an LCD panel, comprising a plurality of data lines disposed in a substrate of the LCD panel along a major-axis direction of the substrate of the LCD panel and a plurality of gate lines disposed in the substrate along a minor-axis direction of the substrate, wherein the gate lines orthogonally intersect the data lines, and a plurality of color sequential displaying areas are defined along the major-axis direction of the substrate;
a data drive circuit, being disposed at one side of the substrate in the minor-axis direction to provide image data to the data lines;
a gate drive circuit, being disposed at one side of the substrate in the major-axis direction to provide a strobe pulse to the gate lines; and
a backlight unit at least comprising red LEDs, green LEDs and blue LEDs, being disposed at one side of the substrate in the major-axis direction.

9. The color sequential LCD device of claim 8, further comprising a light guide plate adjacent to the LCD panel.

10. The color sequential LCD device of claim 9, wherein the LCD device further comprises another data drive circuit disposed at the other side of the substrate in the minor-axis direction.

11. The color sequential LCD device of claim 10, wherein the substrate is divided into a first driving section and a second driving section along the major-axis direction of the substrate, the data lines in the first driving section are disconnected with the data lines in the second driving section, and the data lines in the first driving section and the data lines in the second driving section are connected to corresponding data drive circuits respectively.

12. The color sequential LCD device of claim 11, wherein the number of scan lines in the first driving section is equal to the number of scan lines in the second driving section.

13. The color sequential LCD device of claim 12, wherein the LCD device further comprises another backlight unit disposed at the other side of the substrate in the major-axis direction.

14. The color sequential LCD device of claim 9, wherein the LCD device further comprises another backlight unit disposed at the other side of the substrate in the major-axis direction.

15. The color sequential LCD device of claim 14, wherein the red LEDs, the green LEDs and the blue LEDs are arranged alternately one by one.

16. The color sequential LCD device of claim 8, wherein the number of the scan lines is the same for each of the color sequential displaying areas.
